(19) United States
(12) Patent Application Publication
(10) Pub. No.: US 2016/0057927 A1
(43) Pub. Date: Mar. 3, 2016

(54) GRAIN UNLOADING AUGER WITH DRIBBLE CONTROL DOOR

(71) Applicant: AGCO International GmbH, Neuhausen am Rheinfall (CH)

(72) Inventors: Thomas Mygind BOJSEN, Randers (DK); Brian Jay HOLLATZ, Bassano del Grappa (IT)

(21) Appl. No.: 14/472,621

(22) Filed: Aug. 29, 2014

(51) Int. Cl. A01D 41/12

(52) U.S. Cl. CPC A01D 41/1217

(57) ABSTRACT

A grain unloading system for a combine harvester comprises an unloading tube having a discharge outlet and a helical auger situated in the unloading tube and operable to convey grain towards and through the discharge outlet. A dribble control door serves to inhibit the leakage of grain from the tube when the auger is in a non-operative mode. The door is pivotally connected to the tube adjacent the discharge outlet so as to be pivotally moveable between a closed position and an open position. A lever arm is fixed at one end to the dribble control door, and at the other end to a gas spring which is mounted to the tube. The gas spring is pressurised so as to provide a closing moment to bias the dribble control door into the closed position. The geometry of the lever and gas spring is such that the closing moment increases as the dribble control door moves from the open position to the closed position.

### FIELD OF INVENTION

The invention relates to grain unloading augers typically associated with combine harvesters, and particularly to dribble control doors for limiting lost grain through a discharge opening when the auger is in a non-operative state.

### BACKGROUND

Combine harvesters typically comprise a deployable unloading auger to discharge collected grain into a grain cart brought alongside during the harvesting operation. Unloading augers assemblies include a discharge opening through which the grain is forcibly ejected by a rotating helical auger located inside a tube which is pivotally connected to a turret on the combine.

At the end of an unloading operation, the auger is switched off by the operator. However, residual grain in the tube is known to ‘dribble’ out if the discharge opening is left uncovered. Moreover, movement of the auger tube into the transport position can cause rotation of the inner auger part, in turn, causing dribbling of grain remaining in the tube. Although typically involving small quantities, the dribbling grain is undesirable to the operator.

Dribble control doors have been introduced in an attempt to minimize grain loss through this effect and several different constructions are known. In a simple construction, as disclosed un US-2014/0128134 for example, a coil spring is used to bias a dribble door into a closed position wherein the weight of the grain behind the door during unloading forces the door into an open position. When the unloading auger is switched off, the door snaps closed. However, it has been found that the door in this case closes with the tube still full of grain. When further grain ‘leaks’ down the tube, by sudden acceleration of the combine for example, the door is forced open resulting in undesirable dribbled grain.

U.S. Pat. No. 6,691,861, the contents of which are incorporated by reference herein, discloses a dribble door which is biased into a closed position by a torsion spring. In this case, the closing force increases as the door opens. This inconveniently exacerbates the aforementioned problem and closes the door with a substantial quantity of grain remaining in the tube.

In an attempt to overcome this problem, U.S. Pat. No. 7,584,836, the contents of which are incorporated herein by reference, discloses an unloading system having an actuator-controlled dribble door. Although overcoming the problem of premature closure of the dribble door, or undesirable opening thereof, the system requires a dedicated hydraulic control feed and system which adds extra cost to the machine. Moreover, failure of the system can potentially result in damage to the construction, especially if the system fails with the dribble door in the closed position.

### SUMMARY OF INVENTION

It is an object of the present invention to provide a passive dribble control system which overcomes the aforementioned problems.

According to the invention there is provided a grain unloading system for a combine harvester comprising:
a cylindrical unloading tube having a discharge outlet at the end of the tube,
a helical auger situated in the unloading tube and operable to convey grain towards and through the discharge outlet,
a dribble control door pivotally connected to the tube adjacent the discharge outlet so as to be pivotally moveable between a closed position and an open position,
a lever arm fixed at one end to the dribble control door,
a gas spring connected between the tube and the lever arm, the gas spring being pressurised so as to provide a closing moment to bias the dribble control door into the closed position, wherein the lever and gas spring are arranged such that the closing moment increases as the dribble control door moves from the open position to the closed position.

The invention involves the recognition that a combination of a lever arm and a gas spring alters the closing moment depending on the position of the dribble door so as to allow small quantities of grain to open the door at the end of unloading whilst maintaining a sufficient force to keep the door closed. The gas spring offers a substantially constant closing force whereas the lever presents a low closing moment when the dribble door is in the open position and a high closing moment when the dribble door is in the closed position. As a result, the dribble door remains open even for the small grain flow at the end of the unloading session so as to allow the tube to sufficiently empty.

The dribble control door may be pivotally connected to the tube by a hinge mounted along, or proximate to, a bottom edge of the discharge opening so that the dribble door resides entirely below the auger tube when in the open position. This allows the weight of the grain to force the door open during unloading.

The lever arm preferably extends downwardly from the dribble control door and the gas spring is preferably mounted to the underside of the tube. The lever arm is preferably at least 3 inches long, extending below the door's pivot axis, so as to generate a sufficiently high closing moment when the door is in the closed position.

### BRIEF DESCRIPTION OF DRAWINGS

Further advantages of the invention will become apparent from reading the following description of a specific embodiment with reference to the appended drawings in which:

FIG. 1 is a perspective view of a grain unloading system in accordance with an embodiment of the invention showing the dribble control door in the closed position;

FIG. 2 is a side view of the grain unloading system of FIG. 1;

FIGS. 3 and 4 are perspective and side views respectively of the grain unloading system of FIG. 1 but showing the dribble control door in the open position; and,

FIG. 5 is an upper perspective view of the grain unloading system of FIG. 1 showing the dribble control door in the open position and shown with a delivery spout fitted over the discharge outlet.

### DESCRIPTION OF SPECIFIC EMBODIMENT

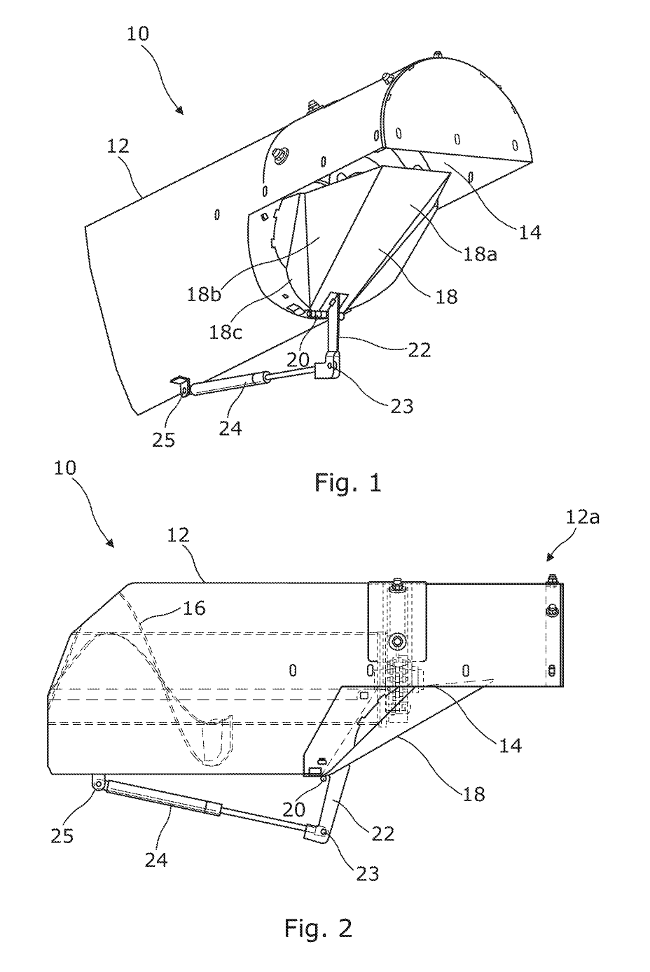

FIGS. 1-5 each illustrate the outboard end of a grain unloading auger fitted to a combine harvester (not shown) and forming part of a grain unloading system. As in known combine harvesters, the unloading auger is pivotally mounted at the not shown end to the combine harvester by a turret disposed at the top of an upright auger also forming part of the unloading system. The auger is swingable between a stowed position, in which the auger is substantially parallel to the longitudinal axis of the combine harvester, and a deployed position in which the auger is substantially perpendicular to the longitudinal axis.

The unloading system 10 comprises a cylindrical unloading tube 12 having at its outboard end 12a (furthest from the turret) a discharge outlet 14 defined by a cut-out half-cylindrical segment in a lower part of the tube 12. A helical auger 16 is situated in the unloading tube 12 and operable to convey grain towards and through the discharge outlet 14. An outboard bearing 17 mounted inside the tube 12 supports the end of the helical auger for rotation.

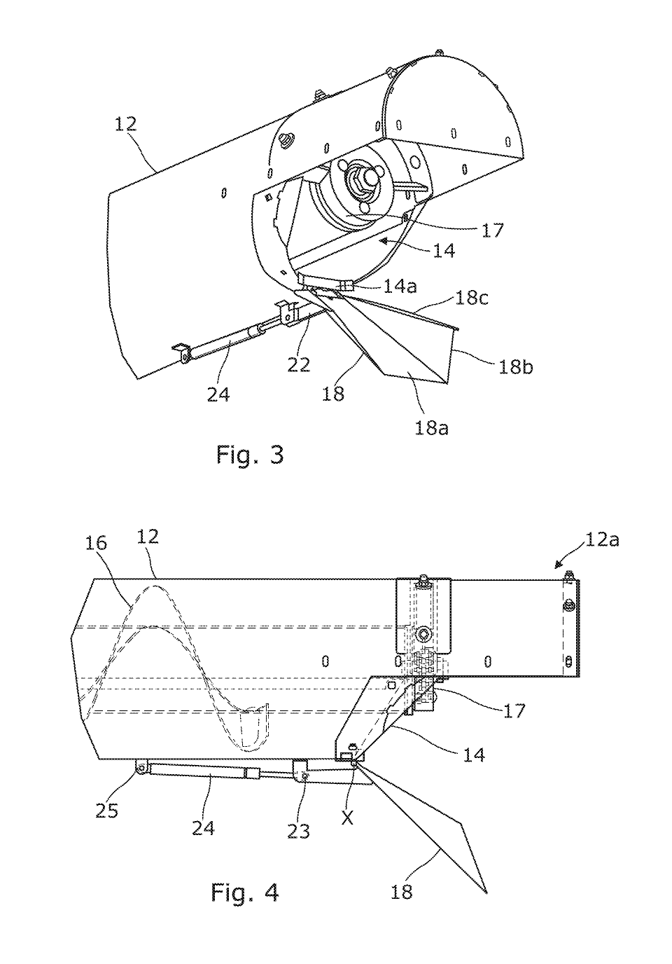

A dribble control door 18 (hereinafter shortened to dribble door) is pivotally connected to the tube 12 adjacent the discharge outlet 14 so as to be pivotally moveable between a closed position (FIGS. 1 and 2) and an open position (FIGS. 3-5). In the closed position the dribble door 18 prevents the leakage of grain laying in the auger tube 12 whilst in the open position the grain is free to fall under gravity through the discharge opening 14.

The dribble door 18 comprises a rigid plate having a central section 18a, inclines side sections 18b and wing sections 18c, together forming a chute or slide which, when in the open position, encourages the grain to fall in a vertical plane parallel with the elongate axis of the tube 12. It should be appreciated however that the dribble door 18 may take various different forms. For example, a simple planar door may be employed. Moreover, it should be understood that the dribble door 18 may, or may not, completely cover the discharge opening provided that the leakage of grain is at least inhibited when in the closed position.

The dribble door 18 is pivotally connected to the tube 12 by a hinge 20 mounted along a bottom edge 14a of the discharge opening 14. The hinge 20 defines a pivot axis X. When in the open position the dribble door 18 resides entirely below the auger tube 12 so as not to prevent any restriction to the discharged grain flow.

A lever arm 22 is fixed to the dribble door 18 adjacent the pivot axis X, the lever arm residing in a vertical plane parallel to the auger axis throughout the movement range between the open and closed positions. The lever arm 22 is approximately 3 inches long and extends substantially downwardly when the dribble door 18 is in the closed position as best seen in FIG. 2.

The lever arm 22 provides a connection point 23 for one end of a gas spring 24, the other end of which is connected to a bracket 25 on the underside of the tube 12. The gas spring exerts a biasing force of 100-150 N depending on the model chosen. By way of example, gas springs supplied by Stabilus (registered trade mark) may be employed.

The gas spring 24 is pressurised so as to provide a closing moment to bias the dribble door 18 into the closed position. The geometry of the lever 22 and gas spring 24 is such that the closing moment increases as the dribble door 18 moves from the open position to the closed position.

Best seen in FIG. 4, when the dribble door 18 is in the open position, the axis of the lever arm 22 is substantially parallel to the axis of the gas spring 24 thus generating a low closing with respect to the pivot axis X. This allows the small flow of grain, typically evident at the end of an unloading event, to overcome the gas spring force and leave the auger tube. Only when this small flow of grain has ceased can the relatively low closing force move the dribble door to the closed position.

As the dribble door closes, the angle between the lever arm 22 and the gas spring increases, thus increasing the closure force (or moment). When the dribble door is in the fully closed position, best seen in FIG. 2, the geometry of the gas spring 24 and lever arm 22 is such that a relatively high closing force is generated thus holding the dribble door closed with sufficient force to prevent grain leakage.

The gas spring offers a substantially constant biasing force over its full extension range.

Advantageously, this allows the geometry with the lever arm 22 to generate a variable closing moment which better meets the functional requirements of the dribble control system.

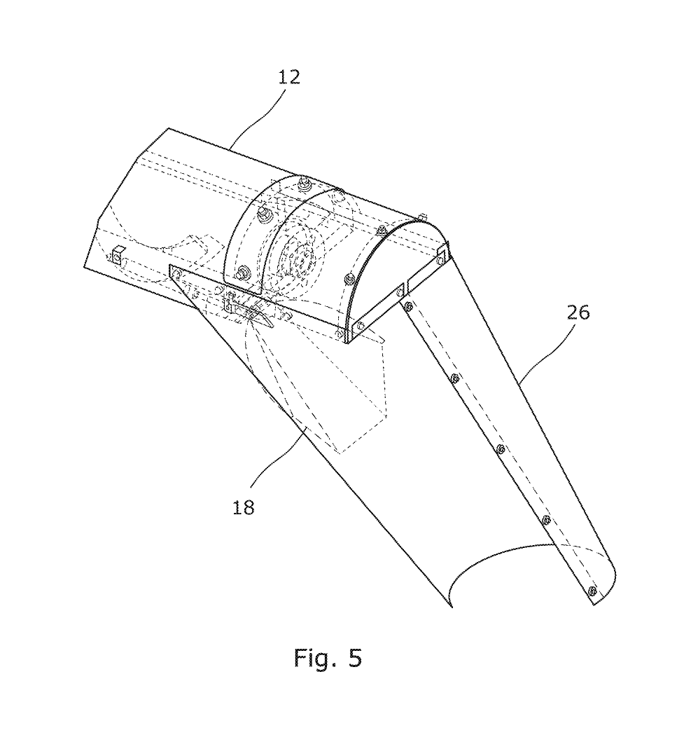

With reference to FIG. 5, a discharge spout 26 may be fixed to the outboard end of the tube 12 so as to generate a grain flow which can be more easily directed during unloading. It can be seen that the dribble door 18 is enclosed or hidden within the spout 26 but is still free to move between the open and closed positions.

1. A grain unloading system for a combine harvester comprising:
a cylindrical unloading tube having a discharge outlet at the end of the tube,
a helical auger situated in the unloading tube and operable to convey grain towards and through the discharge outlet,
a dribble control door pivotally connected to the tube adjacent the discharge outlet so as to be pivotally moveable between a closed position and an open position,
a lever arm fixed at one end to the dribble control door,
a gas spring connected between the tube and the lever arm, the gas spring being pressurised so as to provide a closing moment to bias the dribble control door into the closed position, wherein the lever and gas spring are arranged such that the closing moment increases as the dribble control door moves from the open position to the closed position.

2. A grain unloading system according to claim 1, wherein the dribble control door is pivotally connected to the tube by a hinge mounted along, or proximate to, a bottom edge of the discharge opening.

3. A grain unloading system according to claim 1, wherein the lever extends downwardly from the dribble control door, and wherein the gas spring is mounted to the underside of the tube.

4. A grain unloading system according to claim 1, wherein the discharge opening is defined by a cut-out half-cylindrical segment in a lower part of the tube.

5. A grain unloading system according to claim 1, wherein the dribble door is shaped to provide a chute when in the open position.

6. A grain unloading system according to claim 1, wherein the gas spring and the level arm are substantially aligned when the dribble control door is in the open position.
